(19) United States
(12) Patent Application Publication
(10) Pub. No.: US 2022/0145954 A1
(43) Pub. Date: May 12, 2022

(54) ELECTRIC WHEEL DRIVE UNIT FOR DRIVING A WHEEL OF A MOTOR VEHICLE

(71) Applicant: Schaeffler Technologies AG & Co. KG, Herzogenaurach (DE)

(72) Inventors: Philippe WAGNER, Souffelweyersheim (FR); Aurelien GRAUSS, Mommenheim (FR); Simon ORTMANN, Baden-Baden (DE); Laurent INEICHEN, Strasbourg (FR)

(73) Assignee: Schaeffler Technologies AG & Co. KG, Herzogenaurach (DE)

(21) Appl. No.: 17/598,388

(22) PCT Filed: Feb. 26, 2020
(86) PCT No.: PCT/DE2020/100135

§ 371 Date: Sep. 27, 2021

(30) Foreign Application Priority Data
Mar. 26, 2019 (DE) 102019107740.0

(51) Int. Cl. F16D 65/847; B60K 7/00; F16D 55/225; F16D 65/12

(52) U.S. Cl. CPC F16D 65/847; B60K 7/0007; F16D 2065/1328; F16D 65/128; F16D 55/225

(57) ABSTRACT

An electric wheel drive unit (1) for driving a wheel of a motor vehicle is provided having a brake device (2) for braking the electric wheel drive unit (1) during operation, and a housing (3) which accommodates the brake device (2) in its interior (I). The brake device (2) is designed to convert kinetic energy into heat in order to perform braking, and to suck in a fluid in the axial direction (A) and to feed it in the radial direction (R) in order to cool the brake device (2) by a flow of fluid which is for the most part oriented radially and flows through the brake device (2).

### CROSS-REFERENCE TO RELATED APPLICATIONS

This application is the U.S. National Phase of PCT Appln. No. PCT/DE2020/100135, filed Feb. 26, 2020, which claims priority to DE 102019107740.0, filed Mar. 26, 2019, the entire disclosures of which are incorporated by reference herein.

### TECHNICAL FIELD

The disclosure relates to an electric wheel drive unit for driving a wheel of a motor vehicle.

Various solutions for braking systems in wheel drives are known from the prior art, such as disk brakes.

In particular, thermal endurance is a key focus in the development of a brake. In today's braking systems, the brake disk (or drum) is cooled by the flow of air that is generated when the vehicle moves.

In the case of an electric wheel drive unit (e.g. an e-wheel), there is the problem that the brake or a brake device is integrated in a housing of the wheel drive unit and thus cannot be cooled by an air flow that is generated by the movement of the vehicle.

### SUMMARY

The object of the present disclosure is therefore to provide an electric wheel drive unit for driving a wheel of a motor vehicle, which electric wheel drive unit ensures air cooling of a brake device, is preferably inexpensive and easy to manufacture or assemble, and can preferably be arranged in a space-saving manner in the available space.

According to the disclosure, this object is achieved by one or more of the features disclosed herein. Further advantageous developments are explained below and in the claims.

According to the disclosure, in a first aspect of the present disclosure an electric wheel drive unit for driving a wheel of a motor vehicle comprises:
a brake device for braking the electric wheel drive unit during operation, and
a housing which accommodates the brake device in the interior thereof.

Advantageously, the housing completely encloses the brake device. The brake device is thus enclosed within the housing.

The brake device is preferably designed to convert kinetic energy into heat in order to perform braking, and to suck in a fluid in the axial direction and to convey it in the radial direction in order to cool the brake device by means of a flow of fluid which is for the most part oriented radially and flows through the brake device.

In the present description, the expression “for the most part” is advantageously understood to mean that a radially oriented flow of fluid may also include an axially oriented flow component in addition to the radially oriented flow component. The proportion of the axially oriented component in the total flow of fluid is preferably a maximum of 10%.

It is also possible that the brake device is designed to convey a fluid in the axial direction in order to cool the brake device by means of a further flow of fluid which flows along the outside of the brake device.

In this context, it is advantageous if the housing is designed to guide the axial flow of fluid along the outside of the brake device.

The brake device advantageously comprises a first braking element for converting kinetic energy into heat.

The first braking element is preferably attached radially on the outside to a third braking element, in particular designed as an outer disk carrier.

Moreover, it is advantageous if the first braking element can be rotated relative to the housing.

It is also advantageous if the first braking element is designed as a brake disk and more preferably as an impeller of a centrifugal pump. In this way, the first braking element can simultaneously perform two tasks, namely a braking task and a conveying task. It is therefore possible for the first braking element to give off heat by actively conveying a flow of fluid through the first braking element.

Provision is preferably made for the first braking element to have at least one aperture in the radial direction. This aperture serves to establish a flow of fluid that flows through the first braking element. The first braking element can therefore be actively cooled.

Furthermore, it is advantageous if the first braking element comprises various apertures which are spaced at regular intervals from one another or are equally spaced with respect to one another in the circumferential direction. In this way, the active cooling can be improved.

The at least one aperture of the first braking element advantageously comprises a fluid inlet opening and a fluid outlet opening, between which a fluid flows when the brake device is in operation.

The fluid inlet opening is advantageously arranged radially on the inside compared to the fluid outlet opening.

It is also advantageous if the area of the fluid inlet opening is designed to be smaller than the area of the fluid outlet opening. As a result, an additional suction effect can be generated, as a result of which the flow of fluid through the at least one aperture can be reliably ensured and improved.

Furthermore, it is advantageous if the fluid outlet opening is adapted, in particular geometrically adapted, to a second passageway of a third braking element.

The fluid inlet opening is advantageously adapted, in particular geometrically adapted, to a first passageway of a second braking element.

In the present description, the expression “geometrically adapted” is preferably understood to mean that one component/element/opening is adapted in terms of shape and/or size to the other component/element/opening.

The at least one aperture is preferably designed to be conical, wherein the at least one aperture is preferably designed from radially outside to radially inside as a truncated cone, which tapers radially inward toward a theoretical cone apex.

It is also preferred that the at least one aperture is inclined in the axial direction.

The at least one aperture preferably encloses an angle of between 5 and 25 degrees, more preferably an angle of 15 degrees, to a perpendicular which is oriented perpendicular to a straight line which extends in the axial direction. In this way, a flow of fluid can be generated through the first braking element and flows for the most part in the radial direction and preferably comprises an axially oriented component of a maximum of 10% of the total flow of fluid. Due to the inclined design, the outflow of fluid can be facilitated without it accumulating radially on the outside with only radial orientation of the at least one aperture.

The at least one aperture is advantageously designed to be L-shaped in cross section in the axial direction.

It is also advantageous if the short side of the L-shaped design forms a fluid outlet opening.

Furthermore, it is advantageous if the tip of the long side of the L-shaped design forms a fluid inlet opening on the side facing away from the short side of the L-shaped design.

Provision can also be made for the short side of the L-shaped design to extend away in the direction of the long side of the L-shaped design, which preferably corresponds to the conveying direction of a fluid to be conveyed.

The brake device preferably comprises a second braking element.

It is also preferred that the second braking element comprises at least one first passageway in the radial direction. Fluid can flow through this in order to ensure cooling for the brake device.

The second braking element preferably comprises various first passageways which are spaced at regular intervals from one another or are equally spaced from one another in the circumferential direction. In this way, uniform heat dissipation can be ensured.

The at least one first passageway advantageously comprises an area for a fluid to flow through, which is adapted, in particular geometrically adapted, to a fluid inlet opening of the first braking element.

It is also advantageous if the at least one first passageway and a fluid inlet opening of the first braking element are aligned in one state. In this way, a flow of fluid or a fluid can flow through the at least one first passageway and the fluid inlet opening.

The second braking element preferably comprises at least one first axial passage in the axial direction. Fluid can also flow through the at least one first axial passage in order to ensure cooling for the brake device.

Furthermore, it is preferred that the second braking element comprises various first axial passages which are spaced at regular intervals from one another or are equally spaced from one another in the circumferential direction. In this way, a uniform fluid flow in the axial direction can be realized.

The second braking element is preferably not rotatable relative to the housing. In other words, the second braking element is preferably rigidly connected to the housing.

Furthermore, provision can be made for the second braking element to have a disk carrier, in particular an inner disk carrier.

It is also possible for the second braking element to have a counter-pressure element. Disks of a disk carrier can be pressed against the counter-pressure element.

The disk carrier of the second braking element is advantageously attached to the counter-pressure element.

Furthermore, it is preferred that the at least one first axial passage in the axial direction extends through the disk carrier and through the counter-pressure element. A flow of fluid can thus pass through the inner disk carrier and the counter-pressure element.

A friction lining is preferably arranged between the disks of the disk carrier and the counter-pressure element. With this, the friction or a friction coefficient between the two aforementioned components can be adjusted.

The at least one first axial passage is preferably adapted, in particular geometrically adapted, to at least one second axial passage of a third braking element. The adaptation allows a flow of fluid to pass or flow through all of the axial passages.

It is also preferred that the brake device comprises a third braking element.

Provision can be made for the third braking element to comprise at least one second passageway in the radial direction. In this way it is possible for a flow of fluid to flow in the radial direction through the third braking element.

The third braking element advantageously comprises various second passageways which are spaced at regular intervals from one another or are equally spaced from one another in the circumferential direction. This ensures continuous and uniform cooling.

It is also advantageous if the at least one second passageway comprises an area for a fluid to flow through which is adapted, in particular geometrically adapted, to a fluid outlet opening of the first braking element. In this way, the flow behavior can be adapted and improved.

Furthermore, provision can be made for the first braking element and the third braking element to be attached to one another in such a way that the at least one second passageway and the fluid outlet opening of the at least one aperture are aligned, in order to ensure that fluid can flow through.

Furthermore, it is preferred that the brake device comprises a third braking element.

The third braking element preferably comprises at least one second axial passage in the axial direction. In this way, a flow of fluid can also flow in the axial direction through the third braking element.

The third braking element preferably comprises various second axial passages which are spaced at regular intervals from one another or are equally spaced from one another in the circumferential direction. A uniform and continuous flow of fluid can thus be generated in the axial direction.

It is also advantageous if the at least one second axial passage is adapted, in particular geometrically adapted, to at least one first axial passage of a second braking element. This design ensures that a flow of fluid can flow through several elements or components.

The at least one second axial passage and the at least one first axial passage are advantageously aligned in one state. It is in precisely this state that fluid can flow through both axial passages.

It is also possible for the third braking element to be rotatable relative to the housing.

Provision can also be made for the third braking element to be designed as a disk carrier, in particular as an outer disk carrier.

The electric wheel drive unit advantageously comprises a wheel carrier element, to which the brake device is partly connected.

It is also advantageous if the first braking element of the brake device, in particular the inner disk carrier and/or the counter-pressure element, is connected to the wheel carrier element, preferably in a form-fitting manner. In this way, forces can be transmitted in a simple and safe manner, with no losses.

Provision can also be made for the wheel carrier element to not be rotatable relative to the housing and/or for the first braking element to be connected to the wheel carrier element, in particular directly.

Furthermore, it is advantageous if the first, second and third braking elements are oriented relative to one another in such a way that forces can be transmitted between the braking elements. A braking effect can thus be effected.

Furthermore, it is preferred that the brake device has a pressure element which can be brought into operative connection with the first braking element. An active activation of the brake device is possible with the help of the pressure element.

A friction lining is preferably arranged between the pressure element and the disk carrier of the first braking element. With this, the friction or friction coefficient between the aforementioned components can be adjusted.

Provision can also be made for the pressure element to be arranged and designed in such a way that a force can be exerted on the disk carrier of the second braking element, so that a relative rotation of the third braking element, which is designed as a disk carrier, with respect to the disk carrier of the second braking element can be prevented. In other words, a braking process is described here in which the relative speeds of the second and third braking elements are brought into line with one another.

Preferably, the first braking element is designed to be capable of being brought into contact with the second braking element and with the third braking element and of being released therefrom by moving the pressure element in the axial direction by means of a slave device, in particular a slave cylinder.

Advantageously, the pressure element can be arranged indirectly and in a sealing manner on the first braking element, so that when the pressure element is moved in the axial direction and in the direction of the first braking element in an interior space between the pressure element and the first braking element, the exit opportunities for a flowing fluid or for air conveyed from the inside to radially outside through the first braking element can preferably be limited. In this way, the suction effect of the rotating first braking element with its at least one aperture can be increased. In other words, the sealing contact of the pressure element makes it possible to achieve a more stable negative pressure between the first braking element and the pressure element, as a result of which an air flow with a high cooling effect can be generated.

Furthermore, it is advantageous if an interior space is formed between the pressure element, the first braking element and the second braking element, the imperviousness of which can be increased by moving the pressure element, in particular in the direction of the first braking element, so that exit opportunities for a flowing fluid or for air conveyed from the inside to radially outside through the first braking element can be limited. It is thus possible to increase the suction effect of the rotating first braking element with its at least one aperture in order to ensure a more stable negative pressure between the first braking element, the pressure element and the second braking element. This also makes it possible to achieve an improved flow through the at least one aperture, and thus an air flow with a high cooling effect can be generated.

Preferably, the sealing contact of the pressure element with the first braking element, wherein a friction lining may be arranged therebetween, is ensured or realized when a braking force is generated, or more preferably only when a braking force is generated. The pressure element preferably moves in the direction of the first braking element in order to generate a braking force.

Furthermore, it is preferred that the first and third braking elements, to which a wheel can be connected, can be rotated relative to the housing and to the second braking element.

With regard to the housing, it is advantageous if it comprises at least one axial opening in order to suck in fluid.

The housing advantageously comprises at least one radial opening in order to discharge fluid that has been sucked in.

It is also advantageous if the radial opening is offset axially with respect to the brake device, so that fluid that has been sucked in has to flow past the brake device in the axial direction.

The interior and exterior of the brake device can be cooled by the combination of axial and radial openings. It is advantageous if the housing is designed to guide the axial flow of fluid through the axial openings along the outside of the brake device. Moreover, the axial flow of fluid guided outside the brake device allows an axial velocity component to be added to the radially conveyed flow of fluid, which has absorbed a significantly larger amount of heat when cooling the brake device. As a result, the removal of warm fluid radially outside the brake device can be ensured quickly, so that heat cannot build up.

The brake device preferably has a suction side and a pressure side, wherein the suction side is preferably arranged radially on the inside and, in comparison, the pressure side is arranged radially on the outside and more preferably also axially on the outside.

The inventive concept presented above will be further described in different words below.

This concept preferably consists—in simplified form—in generating active air cooling of a brake device or a brake disk in an electric wheel drive unit or in a so-called e-wheel.

A negative pressure area is preferably generated in the interior of an inner disk carrier or a second braking element in order to suck in cool air from the outside.

This cool air is then preferably conveyed through the brake disk or through the first braking element and between an outer disk carrier/a third braking element and a housing of the electric wheel drive unit in order to cool it.

Lastly, the aforementioned air is preferably conveyed out via openings or radial openings in the housing (negative pressure inside, positive pressure outside).

Here, the present disclosure preferably makes use of the so-called centrifugal pump effect.

To realize this effect, at least one channel or at least one aperture is advantageously arranged in the brake disk or in the first braking element, which is preferably mounted on the rotating outer disk carrier/the third braking element, so that the air can be conveyed from the inside to the outside via centrifugal forces.

The inner plate carrier or the second braking element is advantageously designed radially with openings or with various first passageways so that the air can flow through (can also be added to the outer plate carrier).

The same is preferably also done axially, so that the air can also be conveyed between the inner disk carrier or the second braking element and the housing of the electric wheel drive unit.

A pressure pot is advantageously used to separate the two spaces (negative pressure & positive pressure) from one another.

### BRIEF DESCRIPTION OF THE DRAWINGS

The disclosure will be explained in more detail below using an exemplary embodiment in conjunction with associated drawings. In the drawings:

FIG. 1 schematically shows a sectional view of an electric wheel drive unit according to the disclosure;

FIG. 2 schematically shows a three-dimensional view of the wheel drive unit from FIG. 1, with arrows to illustrate the fluid flow; and

FIG. 3 schematically shows the same view as in FIG. 1, but without reference signs, with arrows to illustrate the fluid flow.

### DETAILED DESCRIPTION

In the description below, the same reference signs will be used for the same components.

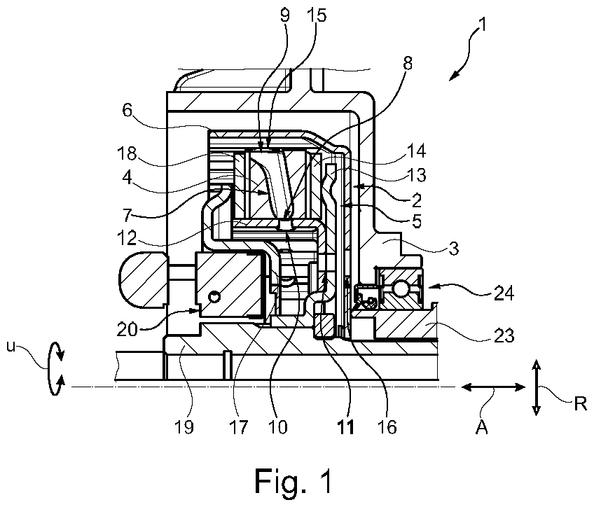

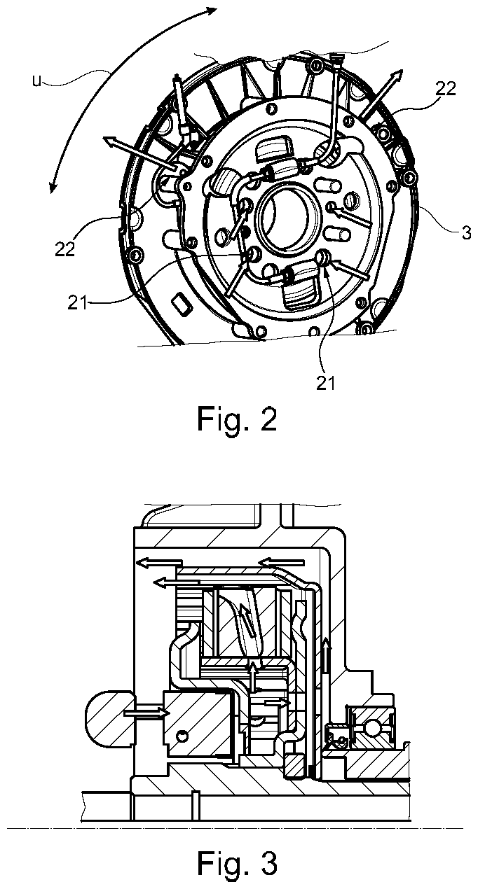

FIG. 1 shows a sectional view of an electric wheel drive unit 1 according to the disclosure, and FIG. 2 shows a three-dimensional view of the wheel drive unit 1 from FIG. 1, with arrows to illustrate the fluid flow.

Furthermore, FIG. 3 shows the same view as in FIG. 1, but without reference signs, with arrows to illustrate the fluid flow.

For the sake of simplicity, all three drawings will be described concurrently below.

As can be seen from FIGS. 1 to 3, an electric wheel drive unit 1 for driving a wheel of a motor vehicle comprises a brake device 2 for braking the electric wheel drive unit 1 during operation.

The wheel drive unit 1 has a housing 3 which accommodates the brake device 2 in the interior I thereof.

The brake device 2 is designed to convert kinetic energy into heat in order to perform braking, and to suck in a fluid in the axial direction A and to convey it in the radial direction R in order to cool the brake device 2 by means of a flow of fluid which is for the most part oriented radially and flows through the brake device 2 (cf. FIG. 3).

Furthermore, the brake device 2 is designed to convey a fluid in the axial direction A in order to cool the brake device 2 by means of a further flow of fluid which flows along the outside of the brake device 2 (cf. FIG. 3). The housing 3 is designed to guide the axial flow of fluid along the outside of the brake device 2.

The brake device 2 has a first braking element 4, a second braking element 5 and a third braking element 6.

The first braking element 4 is used to convert kinetic energy into heat, wherein it is attached radially on the outside to the third braking element 6, designed as an outer disk carrier.

To be precise, the first braking element 4 is designed as a brake disk and as an impeller of a centrifugal pump, and therefore the brake device 2 has a suction side and a pressure side.

The suction side is arranged radially on the inside and, in comparison, the pressure side is arranged radially on the outside (cf. FIG. 3).

As can be seen from FIGS. 1 to 3, the first braking element 4 has various apertures 7 in the radial direction R, which are spaced at regular intervals from one another in the circumferential direction U.

Each aperture 7 has a fluid inlet opening 8 and a fluid outlet opening 9, between which a fluid flows when the brake device 2 is in operation. This is because by rotating the first braking element 4, a fluid within the apertures 7 experiences a centrifugal force, as a result of which the fluid is conveyed or flows from the inside to the outside.

Furthermore, the drawings show that the fluid inlet opening 8 is arranged radially on the inside compared to the fluid outlet opening 9, wherein the area of the fluid inlet opening 8 is designed to be smaller than the area of the fluid outlet opening 9. The suction effect can thus be improved to an extent.

Each fluid outlet opening 9 is geometrically adapted, i.e. in terms of size and shape, to second passageways 15 of the third braking element 6 and each fluid inlet opening 8 is adapted to first passageways 10 of the second braking element 5.

Furthermore, it is shown in particular in FIG. 1 that one aperture or each aperture 7 is conical and is designed from radially outside to radially inside as a truncated cone, which tapers radially inward toward a theoretical cone apex.

The aperture 7 shown as an example is also inclined in the axial direction A, wherein the aperture 7 encloses an angle of 15 degrees to a perpendicular, which is oriented perpendicular to a straight line which extends in the axial direction A.

In addition, FIG. 1 shows that the aperture 7 is designed to be L-shaped in cross section in the axial direction A, wherein the short side of the L-shaped design forms a fluid outlet opening 9 and the tip of the long side of the L-shaped design forms a fluid inlet opening 8 on the side facing away from the short side of the L-shaped design.

The short side of the L-shaped design extends away in the direction of the long side of the L-shaped design, which corresponds to the conveying direction of a fluid to be conveyed (cf., in particular, FIG. 3 with an exemplary illustration of a fluid flow through the electric wheel drive unit 1).

As already mentioned and as shown in the drawings, the brake device 2 has a second braking element 5, which comprises various first passageways 10 which are spaced at regular intervals from one another in the circumferential direction U.

Each passageway 10 has an area for a fluid to flow through, which area is geometrically adapted to the fluid inlet opening 8 of the first braking element 4.

In one state, a first passageway 10 and a fluid inlet opening 8 of the first braking element 4 are aligned. In this way, a flow of fluid can flow from the first passageway 10 to the fluid inlet opening 8.

As can also be seen from FIGS. 1 to 3, the second braking element 5 has various first axial passages 11 which are spaced at regular intervals from one another in the circumferential direction U.

In the present exemplary embodiment, the second braking element 5 is composed of an inner disk carrier 12 and a counter-pressure element 13, wherein the disk carrier 12 is attached to the counter-pressure element 13. The counter-pressure element 13 is used to provide a stop against which the disks can be displaced.

The first axial passage 11 extends in the axial direction A through the disk carrier 12 and through the counter-pressure element 13.

A friction lining 14 is arranged between the disks of the disk carrier 12 and the counter-pressure element 13, with which the friction or the friction coefficient between the aforementioned elements can be adjusted in a targeted manner.

It can also be seen in particular in FIG. 2 that the first axial passage 11 is geometrically adapted, i.e. in terms of size and shape, to a second axial passage 16 of the third braking element 6.

Furthermore, all of the drawings show—as already mentioned—that the brake device 2 has a third braking element 6, which comprises various second passageways 15 which are spaced at regular intervals from one another in the circumferential direction U.

Each second passageway 15 has an area for a fluid to flow through which is geometrically adapted, i.e. adapted in terms of shape and size, to the fluid outlet opening 10 of the first braking element 4.

FIG. 2 shows that the first braking element 4 and the third braking element 6 are attached to one another in such a way that each second passageway 15 and each fluid outlet opening 9 are aligned in order to ensure that fluid can flow through.

Furthermore, the third braking element 6 has various second axial passages 16, which are spaced at regular intervals from one another in the circumferential direction U.

Each second axial passage 16 is also geometrically adapted in terms of size and shape to each first axial passage 11 of the second braking element 5, in order to optimally ensure a continuous flow of fluid.

In this case, there is a state in which the second axial passages 16 and the first axial passages 11 are aligned, as a result of which a flow of fluid through both axial passages 16, 11 is facilitated.

It can also be seen from FIGS. 1 to 3 that the third braking element 6 is designed as an outer disk carrier.

Furthermore, as shown in FIG. 1, the electric wheel drive unit 1 has a wheel carrier element 19 to which the brake device 2 is partly connected, wherein the inner disk carrier 12 and the counter-pressure element 13 are connected to the wheel carrier element 19 in a form-fitting manner.

While the first and third braking elements 4, 6 are rotatable relative to the housing 3, the second braking element 5 and the wheel carrier element 19 are not rotatable relative to the housing 3, wherein the second braking element 5 is directly connected to the wheel carrier element 19.

FIGS. 1 and 3 also show that the first, second and third braking elements 4, 5, 6 are aligned with one another in such a way that forces can be transmitted between the braking elements 4, 5, 6.

Furthermore, FIG. 1 shows that the brake device 2 has a pressure element 17 which can be brought into operative connection with the second braking element 5, wherein a friction lining 18 is arranged between the pressure element 17 and the disk carrier 12 of the second braking element 5. With the friction lining, the friction between the aforementioned elements can be adjusted in a targeted manner.

The pressure element 17 is also arranged and designed in such a way that a force can be exerted on the disks of the second and third braking elements 5, 6, so that a relative rotation of the third braking element 6, which is designed as a disk carrier, with respect to the disk carrier 12 of the second braking element 5 can be prevented.

Thus, the first braking element 4 is designed to be capable of being brought into contact with the second braking element 5 and with the third braking element 6 and of being released therefrom by moving the pressure element 17 in the axial direction A by means of a slave device 20, in particular a slave cylinder 20.

The pressure element 17 is thus arranged indirectly and in a sealing manner on the first braking element 4, so that when the pressure element 17 is moved in the axial direction A and in the direction of the first braking element 4 in an interior space between the pressure element 17 and the first braking element 4, the exit opportunities for a flowing fluid or for air conveyed from the inside to radially outside through the first braking element are limited. In this way, the suction effect of the rotating first braking element 4 with its apertures 7 can be increased.

In other words, the sealing contact of the pressure element 17 makes it possible to achieve a more stable negative pressure between the first braking element 4 and the pressure element 17, as a result of which an air flow with a high cooling effect can be generated.

The sealing contact of the pressure element 4 with the first braking element 4, wherein the friction lining 18 is also arranged therebetween (cf. FIG. 1), is preferably only ensured or realized when a braking force is generated.

To be more precise, an interior space is formed between the pressure element 17, the first braking element 4 and the second braking element 5, the imperviousness of which can be increased by moving the pressure element 4, in particular in the direction of the first braking element 4, so that exit opportunities for a flowing fluid or for air are limited.

It is thus possible to increase the suction effect of the rotating first braking element 4 with its apertures 7 in order to ensure a more stable negative pressure between the first braking element 4, the pressure element 17 and the second braking element 5.

As shown in FIG. 2, in order to suck in fluid the housing 3 has various axial openings 21, and in order to discharge fluid the housing 3 has various radial openings 22, wherein the radial openings 22 are offset axially relative to the brake device 2, so that fluid that has been sucked in has to flow past the brake device 2 in the axial direction A (cf. FIG. 3).

Furthermore, the drawings show that the wheel drive unit 1 comprises a shaft 23 to which the brake device 2 is partly connected, wherein the third braking element 6 of the brake device 2 is connected to the shaft 22 in a form-fitting and/or force-fitting manner.

Here, the shaft 23 is rotatable relative to the housing 3 and to the second braking element 5, wherein a drive unit, in particular an electric motor (not shown), is attachable to the shaft 23.

FIGS. 1 and 3 also show that a bearing unit 24 is arranged between the shaft 23 and the housing 3, so that these two can be rotated relative to one another.

Lastly, it should be noted that the housing 3 can be fixedly attached to a vehicle frame.

### LIST OF REFERENCE SIGNS

1 Wheel drive unit
2 Brake device
3 Housing
4 First braking element
5 Second braking element
6 Third braking element
7 Aperture
8 Fluid inlet opening
9 Fluid outlet opening
10 First passageway
11 First axial passage
12 Inner disk carrier
13 Counter-pressure element
14 Friction lining
15 Second passageway
16 Second axial passage
17 Pressure element
18 Friction lining
19 Wheel carrier element
20 Slave device
21 Axial opening
22 Radial opening
23 Shaft
24 Bearing unit
A Axial direction
R Radial direction
U Circumferential direction
I Interior of the housing

1. An electric wheel drive unit for driving a wheel of a motor vehicle, the electric wheel drive unit comprising:
a brake assembly configured for braking the electric wheel drive unit during operation;
a housing which accommodates the brake assembly in an interior thereof;
the brake assembly is configured to convert kinetic energy into heat in order to perform braking, and to suck in a fluid in an axial direction and to convey the fluid in a radial direction in order to cool the brake assembly by a flow of the fluid which is for the most part oriented radially and flows through the brake assembly.

2. The electric wheel drive unit according to claim 1,
wherein the brake assembly is further configured to convey the fluid in the axial direction in order to cool the brake assembly by a further flow of the fluid which flows along an outside of the brake assembly, and
wherein the housing is configured to guide the axial flow of the fluid along the outside of the brake assembly.

3. The electric wheel drive unit according to claim 1,
wherein the brake assembly comprises a first braking element configured for converting kinetic energy into heat,
the first braking element is attached on an outside to a third braking element,
the first braking element is rotatable relative to the housing, and
the first braking element is a brake disk.

4. The electric wheel drive unit according to claim 3,
wherein the first braking element has at least one aperture in the radial direction, and
the at least one aperture of the first braking element comprises a fluid inlet opening and a fluid outlet opening, between which the fluid flows when the brake assembly is in operation.

5. The electric wheel drive unit according to claim 4,
wherein the at least one aperture is conical, or
the at least one aperture a truncated cone from radially outside to radially inside, which tapers radially inward toward a theoretical cone apex.

6. The electric wheel drive unit according to claim 4,
wherein the brake assembly comprises a second braking element,
the second braking element comprises at least one first passageway in the radial direction, and
the at least one first passageway comprises an area for the fluid to flow through which is adapted to lead to a fluid inlet opening of the first braking element.

7. The electric wheel drive unit according to claim 4,
the brake assembly comprises a second braking element,
the second braking element comprises at least one first axial passage in the axial direction, and
the second braking element is not rotatable relative to the housing.

8. The electric wheel drive unit according to claim 4,
the third braking element comprises at least one second passageway in the radial direction, and
the at least one second passageway comprises an area for the fluid to flow through which is adapted to lead to a fluid outlet opening of the first braking element.

9. The electric wheel drive unit according to claim 4,
the third braking element comprises at least one second axial passage in the axial direction, and
the third braking element is rotatable relative to the housing.

10. The electric wheel drive unit according to claim 6,
wherein the brake assembly has a pressure element which is configured to be brought into operative connection with the first braking element to activate the brake assembly,
a friction lining is arranged between the pressure element and a disk carrier of the first braking element, and
the first braking element is configured to be brought into contact with the second braking element and with the third braking element and of being released therefrom by moving the pressure element in the axial direction (A) by a slave device.

11. The electric wheel drive unit according to claim 3, wherein the third braking element comprises an outer disk carrier.

12. The electric wheel drive unit according to claim 3, wherein the first braking element is an impeller of a centrifugal pump.

13. The electric wheel drive unit according to claim 4, wherein the fluid inlet opening is arranged radially on an inside compared to the fluid outlet opening.

14. The electric wheel drive unit according to claim 4, wherein an area of the fluid inlet opening is smaller than an area of the fluid outlet opening.

15. The electric wheel drive unit according to claim 5, wherein the at least one aperture is inclined in an axial direction, and the at least one aperture encloses an angle of between 5 and 25 degrees to a perpendicular which is oriented perpendicular to a straight line which extends in the axial direction.

16. The electric wheel drive unit according to claim 6, wherein the at least one first passageway and a fluid inlet opening of the first braking element are aligned in one state.

17. The electric wheel drive unit according to claim 7, wherein the second braking element has an inner disk carrier.

18. The electric wheel drive unit according to claim 8, wherein the first braking element and the third braking element are attached to one another such that the at least one second passageway and the fluid outlet opening are aligned, in order to ensure that the fluid can flow through.

19. The electric wheel drive unit according to claim 9, wherein the third braking element is an outer disk carrier.

20. The electric wheel drive unit according to claim 10, wherein the pressure element is arranged indirectly and in a sealing manner on the first braking element, so that when the pressure element is moved in the axial direction and in a direction of the first braking element in an interior space between the pressure element and the first braking element, exit opportunities for a flowing fluid which is conveyed from inside to radially outside through the first braking element is limited, and
an interior space is formed between the pressure element, the first braking element and the second braking element, an imperviousness of which is increased by moving the pressure element so that exit opportunities for the flowing fluid are limited.
